(19) United States
(12) Patent Application Publication
(10) Pub. No.: US 2018/0134385 A1
(43) Pub. Date: May 17, 2018

(54) ELECTRONIC DEVICE AND METHOD FOR CONTROLLING MOVING DEVICE USING THE SAME

(71) Applicant: SAMSUNG ELECTRONICS CO., LTD., Suwon-si (KR)

(72) Inventors: Chanwon Lee, Suwon-si (KR); Boram Namgoong, Suwon-si (KR)

(21) Appl. No.: 15/798,850

(22) Filed: Oct. 31, 2017

(30) Foreign Application Priority Data
Nov. 15, 2016 (KR) 10-2016-0151723

(51) Int. Cl. B64C 39/02; A63H 30/04; G05D 1/00; G06F 3/0488; G06F 3/041

(52) U.S. Cl. CPC B64C 39/024; A63H 30/04; G05D 1/0016; G06F 2203/04104; G06F 3/0416; G06F 3/0414; G06F 3/0488

(57) ABSTRACT

An electronic device and a method for controlling a moving device using the same are provided. The electronic device includes a radio frequency (RF) unit comprising RF circuitry configured to communicate with a moving device; a memory; a touch screen configured to display a user interface for controlling the moving device; and a processor electrically connected to the RF unit, the memory, and the touch screen, wherein the memory includes instructions that when executed by the processor, configure the processor to determine a function of the moving device based on a pressure intensity of a touch input and a moving direction of the touch input when the touch input is detected in the user interface and to transmit a control signal of the determined function of the moving device to the moving device through the RF unit.

### CROSS-REFERENCE TO RELATED APPLICATION

This application is based on and claims priority under 35 U.S.C. § 119 to Korean Patent Application No. 10-2016-0151723 filed on Nov. 15, 2016, which is incorporated by reference herein in its entirety.

### BACKGROUND

### Field

The present disclosure relates generally to an electronic device and a method for controlling a moving device using the same.

### Description of Related Art

A drone is an example of a moving device is a small unmanned aerial vehicle, and nowadays, while the drone is commercially available, the drone has been used in various fields such as camera photographing. In general, a drone may perform a function such as flying and picture photographing according to a manipulation signal received from a drone control device connected by wireless. For example, the drone may be controlled using a smart phone in which almost all persons use as a drone control device. Accordingly, a user may fly a drone to a desired area using the smart phone without a separate equipment and take a picture of the desired area.

However, there are many functions that can be performed using the drone, and in order to control such functions, many manipulation buttons are required. Because many manipulation buttons are provided, when an electronic device such as the smart phone displays an image received from the drone, the image may be covered or obscured by the many manipulation buttons. Further, in order to manipulate the drone, many manipulation buttons should be used; thus, there is a problem that the user should continue to view the electronic device instead of the drone.

Further, because of many functions that can be performed using the drone, it may be difficult for the user to manipulate the drone.

### SUMMARY

The present disclosure addresses the above problems and provides an electronic device and a method for controlling a moving device using the same that can control a function of the moving device based on a movement of the electronic device and/or pressure intensity of a detected touch input decreasing the need for many manipulation buttons.

In accordance with an example aspect of the present disclosure, an electronic device includes a radio frequency (RF) unit comprising RF circuitry configured to communicate with a moving device; a memory; a touch screen configured to display a user interface for controlling the moving device; and a processor electrically connected to the RF unit, the memory, and the touch screen, wherein the memory includes instructions which, when executed, configure the processor to determine a function of the moving device based on pressure intensity of a touch input and a moving direction of the touch input when the touch input is detected in the user interface and to transmit a control signal of the determined function of the moving device to the moving device through the RF unit.

In accordance with another example aspect of the present disclosure, a method for controlling a moving device in an electronic device includes displaying a user interface for controlling the moving device connected through an RF unit comprising RF circuitry; determining, when a touch input is detected in the user interface, a function of the moving device based on pressure intensity of the touch input and a moving direction of the touch input; and transmitting a control signal of the determined function of the moving device to the moving device through the RF unit.

### BRIEF DESCRIPTION OF THE DRAWINGS

The above and/or other aspects, features, and attendant advantages of the present disclosure will be apparent and more readily appreciated from the following detailed description, taken in conjunction with the accompanying drawings, in which like reference numerals refer to like elements, and wherein:

FIG. 1 is a block diagram illustrating an example configuration of an electronic device in a network environment according to various example embodiments of the present disclosure;

FIG. 2 is a block diagram illustrating an example configuration of an electronic device according to various example embodiments of the present disclosure;

FIG. 3 is a block diagram illustrating an example configuration of a program module according to various example embodiments of the present disclosure;

FIG. 4A is a block diagram illustrating an example configuration of an electronic device according to various example embodiments of the present disclosure;

FIG. 4B is a diagram illustrating an example electronic device and an example moving device connected through an RF unit according to various example embodiments of the present disclosure;

FIG. 5 is a flowchart illustrating an example method for controlling a moving device according to various example embodiments of the present disclosure;

FIG. 6 is a diagram illustrating an example method for controlling a moving device according to various example embodiments of the present disclosure;

FIGS. 7A and 7B are diagrams illustrating an example method for controlling a moving device according to various example embodiments of the present disclosure;

FIG. 8 is a flowchart illustrating an example method for controlling a camera function of a moving device according to various example embodiments of the present disclosure;

FIG. 9 is a diagram illustrating an example method for controlling a camera function of a moving device according to various example embodiments of the present disclosure;

FIG. 10 is a flowchart illustrating an example method for controlling a moving device according to various example embodiments of the present disclosure; and

FIG. 11 is a diagram illustrating an example method for controlling a moving device according to various example embodiments of the present disclosure.

### DETAILED DESCRIPTION

Hereinafter, the present disclosure is described with reference to the accompanying drawings. Although various example embodiments are illustrated in the drawings and related detailed descriptions are discussed in the disclosure, the present disclosure may have various modifications and several embodiments. However, various embodiments of the present disclosure are not limited to a specific implementation form and it should be understood that the present disclosure includes all changes and/or equivalents and substitutes included in the various embodiments of the present disclosure. In connection with descriptions of the drawings, similar components are designated by the same reference numeral.

In various embodiments of the present disclosure, the terms such as “include”, “have”, “may include” or “may have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of the various embodiments but does not limit the corresponding components. For example, the above expressions do not limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element also may be referred to as the first structural element.

When it is stated that a component is “(operatively or communicatively) coupled to” or “connected to” another component, the component may be directly coupled or connected to another component or a new component may exist between the component and another component. On the other hand, when it is stated that a component is “directly coupled to” or “directly connected to” another component, a new component does not exist between the component and another component.

In the present disclosure, the expression “configured (or set) to do” may be used interchangeably with, for example, “suitable for doing,” “having the capacity to do,” “designed to do,” “adapted to do,” “made to do,” or “capable of doing.” The expression “configured (or set) to do” may not necessarily be used to refer to only something in hardware for which it is “specifically designed to do.” Instead, the expression “a device configured to do” may indicate that the device is “capable of doing” something with other devices or parts. For example, the expression “a processor configured (or set) to do A, B and C” may refer, without limitation, to a dedicated processor (e.g., an embedded processor) or a generic-purpose processor (e.g., CPU or application processor or any other processing circuitry) that may execute one or more software programs stored in a memory device to perform corresponding functions.

According to various embodiments, examples of the electronic device may include a smartphone, a tablet Personal Computer (PC), a mobile phone, a video phone, an electronic book reader, a desktop PC, a laptop PC, a netbook computer, a workstation, a server, a Personal Digital Assistant (PDA), a Portable Multimedia Player (PMP), an MP3 player, a medical device, a camera, and a wearable device, or the like, but is not limited thereto. Examples of the wearable device may include an accessory type device (such as, watch, ring, bracelet, ankle bracelet, necklace, glasses, contact lens, and Head-Mount Device (HMD)), a textile or clothes type device (such as electronic clothes), a body-attached type (such as skin pad and tattoo), and a bio-implemented type, or the like, but is not limited thereto.

According to an embodiment, examples of the electronic device may include a television, a Digital Video Disc (DVD) player, an audio player, a refrigerator, an air conditioner, a cleaner, an oven, a microwave oven, a laundry machine, an air purifier, a set-top box, a home automation control panel, a security control panel, a media box (such as Samsung HomeSync™, apple TV™, and google TV™), a game console (such as Xbox™ and PlayStation™), an electronic dictionary, an electronic key, a camcorder, and an electronic frame, or the like, but is not limited thereto.

According to an embodiment, examples of the electronic device may include a medical device (such as portable medical sensors (including glucometer, heart rate sensor, tonometer, and body thermometer), Magnetic Resonance Angiography (MRA) device, Magnetic Resonance Imaging (MRI) device, Computed Tomography (CT) device, camcorder, and microwave scanner), a navigation device, a Global navigation Satellite System (GNSS), an Event Data Recorder (EDR), a Flight Data Recorder (FDR), an automotive infotainment device, marine electronic equipment (such as marine navigation system and gyro compass), aviation electronics (avionics), an automotive head unit, an industrial or household robot, an Automatic Teller Machine (ATM), a Point Of Sales (POS) terminal, and an Internet-of-Things (IoT) device (such as electric bulb, sensor, sprinkler system, fire alarm system, temperature controller, street lamp, toaster, fitness equipment, hot water tank, heater, and boiler), or the like, but is not limited thereto.

According to an embodiment, examples of the electronic device may include furniture, a building/structure, a part of a vehicle, an electronic board, an electronic signature receiving device, a projector, and a sensor (such as water, electricity, gas, and electric wave meters), or the like, but is not limited thereto. According to various embodiments, the electronic device may be flexible or a combination of at least two of the aforementioned devices. According to an embodiment, the electronic device is not limited to the aforementioned devices.

In the disclosure, the term “user” may denote a person who uses the electronic device or a device (e.g., artificial intelligent electronic device) which uses the electronic device.

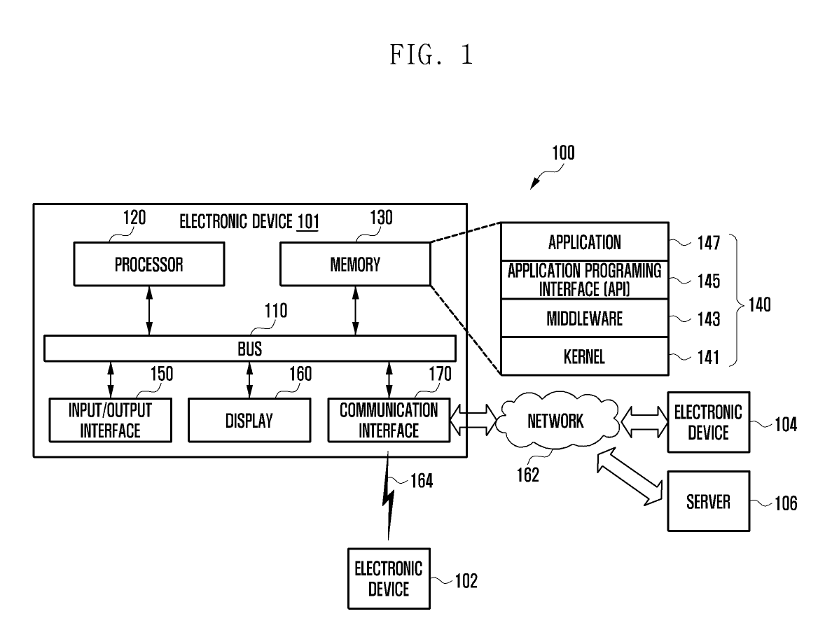

FIG. 1 is a block diagram illustrating an example configuration of an electronic device in a network environment according to various example embodiments of the present disclosure.

Referring to FIG. 1, electronic device (e.g., an electronic device 101, a first external device 102 and a second external device 104) and/or server 106 may be connected with network 162 through short-range communication 164.

The electronic device 101, in a network environment 100, includes a bus 110, a processor (e.g., including processing circuitry) 120, a memory 130, an input/output interface (e.g., including input/output circuitry) 150, a display 160, and a communication interface (e.g., including communication circuitry) 170. According to some embodiments, the electronic device 101 may omit at least one of the components or further include another component.

The bus 110 may be a circuit connecting the above described components 110-170 and transmitting communication (e.g., a control message or data) between the above described components.

The processor 120 may include various processing circuitry, such as, for example, and without limitation one or more of a dedicated processor, a central processing unit (CPU), application processor (AP) or communication processor (CP). For example, the processor 120 may control at least one component of the electronic device 101 and/or execute calculation relating to communication or data processing.

The memory 130 may include volatile and/or non-volatile memory. For example, the memory 130 may store command or data relating to at least one component of the electronic device 101. According to some embodiment, the memory 130 may store software and/or program 140. For example, the program 140 may include a kernel 141, middleware 143, an application programming interface (API) 145, and/or an application 147 and so on. At least one portion of the kernel 141, the middleware 143 and the API 145 may be defined as operating system (OS).

The kernel 141 controls or manages system resources (e.g., the bus 110, the processor 120, or the memory 130) used for executing an operation or function implemented by the remaining other program, for example, the middleware 143, the API 145, or the application 147. Further, the kernel 141 provides an interface for accessing individual components of the electronic device 101 from the middleware 143, the API 145, or the application 147 to control or manage the components.

The middleware 143 performs a relay function of allowing the API 145 or the application 147 to communicate with the kernel 141 to exchange data. Further, in operation requests received from the application 147, the middleware 143 performs a control for the operation requests (e.g., scheduling or load balancing) by using a method of assigning a priority, by which system resources (e.g., the bus 110, the processor 120, the memory 130 and the like) of the electronic device 101 may be used, to the application 147.

The API 145 is an interface by which the application 147 may control a function provided by the kernel 141 or the middleware 143 and includes, for example, at least one interface or function (e.g., command) for a file control, a window control, image processing, or a character control.

The input/output interface 150 may include various input/output circuitry configured to provide an interface to transmit command or data input by a user or another external device to another component(s) of the electronic device 101. Further, the input/output interface 150 may output the command or data received from the another component(s) of the electronic device 101 to the user or the another external device.

The display 160 may include, for example, liquid crystal display (LCD), light emitting diode (LED), organic LED (OLED), or micro electro mechanical system (MEMS) display, or electronic paper display, or the like, but is not limited thereto. The display 160 may display, for example, various contents (text, image, video, icon, or symbol, and so on) to a user. The display 160 may include a touch screen, and receive touch, gesture, approaching, or hovering input using a part of body of the user.

The communication interface 170 may include various communication circuitry configured to set communication of the electronic device 101 and external device (e.g., a first external device 102, a second external device 104, or a server 1106). For example, the communication interface 170 may be connected with the network 162 through wireless communication or wired communication and communicate with the external device (e.g., a second external device 104 or server 106).

Wireless communication may use, as cellular communication protocol, at least one of LTE (long-term evolution), LTE-A (LTE Advance), CDMA (code division multiple access), WCDMA (wideband CDMA), UMTS (universal mobile telecommunications system), WiBro (Wireless Broadband), GSM (Global System for Mobile Communications), and the like, for example. A short-range communication 164 may include, for example, at least one of Wi-Fi, Bluetooth, Near Field Communication (NFC), Magnetic Secure Transmission or near field Magnetic data Stripe Transmission (MST), and Global Navigation Satellite System (GNSS), and the like. The GNSS may include at least one of, for example, a Global Positioning System (GPS), a Global navigation satellite system (Glonass), a Beidou Navigation Satellite System (hereinafter, referred to as “Beidou”), and Galileo (European global satellite-based navigation system). Hereinafter, the “GPS” may be interchangeably used with the “GNSS” in the disclosure. Wired communication may include, for example, at least one of USB (universal serial bus), HDMI (high definition multimedia interface), RS-232 (recommended standard-232), POTS (plain old telephone service), and the like. The network 162 may include telecommunication network, for example, at least one of a computer network (e.g., LAN or WAN), internet, and a telephone network.

Each of the first external device 102 and the second external device 104 may be same type or different type of device with the electronic device 101. According to some embodiment, the server 106 may include one or more group of servers. According to various example embodiments, at least one portion of executions executed by the electronic device may be performed by one or more electronic devices (e.g., external electronic device 102, 104, or server 106). According to some embodiments, when the electronic device 101 should perform a function or service automatically, the electronic device 101 may request performing of at least one function to another device (e.g., external electronic device 102, 104, or server 106). The another device (e.g., external electronic device 102, 104, or server 106) may perform the requested function or additional function, and may transfer a result of the performance to the electronic device 101. The electronic device 101 may additionally process the received result to provide the requested function or service. For the above, cloud computing technology, distributed computing technology, or client-server computing technology may be used, for example.

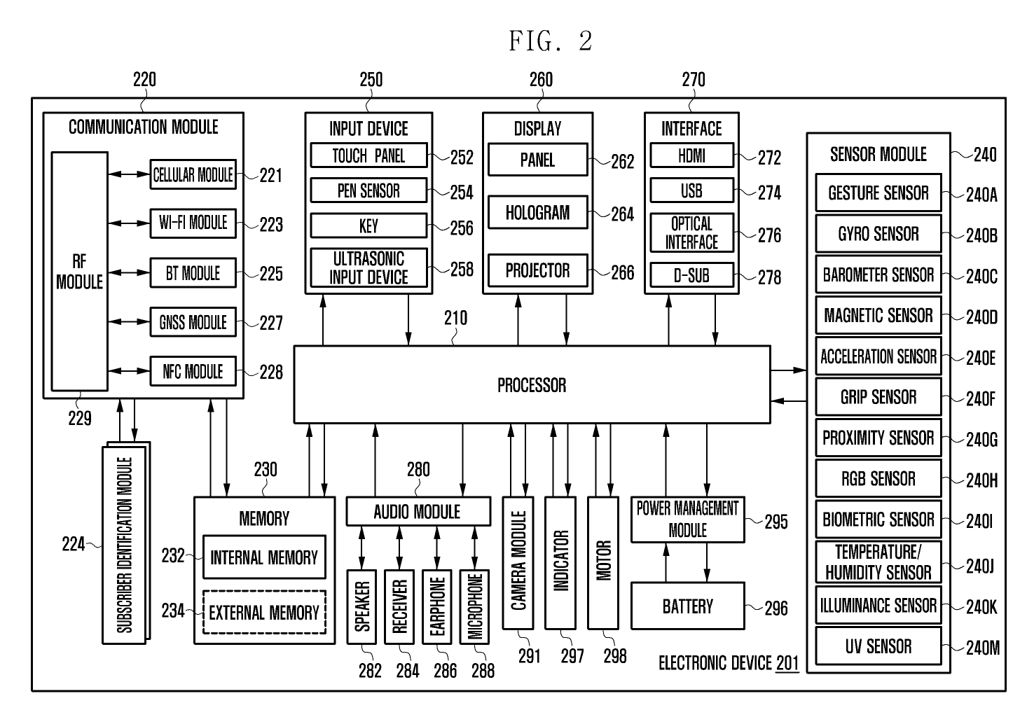

FIG. 2 is a block diagram illustrating an example configuration of an electronic device according to various example embodiments of the present disclosure.

Referring to FIG. 2, an electronic device 201 may include, for example, a whole or a part of the electronic device 101 illustrated in FIG. 1. The electronic device 201 includes one or more APs (e.g., including processing circuitry) 210, a communication module (e.g., including communication circuitry) 220, a subscriber identification module (SIM) card 224, a memory 230, a sensor module 240, an input device (e.g., including input circuitry) 250, a display 260, an interface (e.g., including interface circuitry) 270, an audio module 280, a camera module 291, a power managing module 295, a battery 296, an indicator 297, and a motor 298.

The AP 210 may include various processing circuitry and operates an OS or an application program to control a plurality of hardware or software component elements connected to the AP 210 and execute various data processing and calculations including multimedia data. The AP 210 may be implemented by, for example, a system on chip (SoC). According to an embodiment, the application processor 210 may further include a graphics processing unit (GPU) and/or image signal processor. The AP 210 may include at least one portion of components illustrated in FIG. 2 (e.g., a cellular module 221). The AP 210 may load command or data received from at least one of another component (e.g., non-volatile memory), store various data in the non-volatile memory.

The communication module 220 may include the same or similar components with the communication interface 170 of FIG. 1. The communication module 220 may include various communication circuitry therein, such as, for example, and without limitation, a cellular module 221, a Wi-Fi module 223, a BT module 225, a GPS module 227, a NFC module 228, and a radio frequency (RF) module 229.

The cellular module 221 provides a voice, a call, a video call, a short message service (SMS), or an internet service through a communication network (e.g., LTE, LTE-A, CDMA, WCDMA, UMTS, WiBro, GSM and the like). Further, the cellular module 221 may distinguish and authenticate electronic devices within a communication network by using a SIM (e.g., the SIM card 224). According to an embodiment, the cellular module 221 performs at least some of the functions which may be provided by the AP 210. For example, the cellular module 221 may perform at least some of the multimedia control functions. According to an embodiment, the cellular module 221 may include a CP.

Each of the Wi-Fi module 223, the BT module 225, the GPS module 227, and the NFC module 228 may include, for example, a processor for processing data transmitted/received through the corresponding module.

According to various embodiments, at least part of the cellular module 221, the Wi-Fi module 223, the BT module 225, the GPS module 227, and the NFC module 228 may be included in one integrated chip (IC) or one IC package.

The RF module 229 transmits/receives data, for example, an RF signal. Although not illustrated, the RF module 229 may include, for example, a transceiver, a power amp module (PAM), a frequency filter, a low noise amplifier (LNA), antenna and the like.

According to various embodiments, at least one of the cellular module 221, the Wi-Fi module 223, the BT module 225, the GPS module 227, and the NFC module 228 may transmit/receive an RF signal through a separate RF.

The SIM card 224 may refer, for example, to a card including a SIM and may be inserted into a slot formed in a particular portion of the electronic device. The SIM card 224 includes unique identification information (e.g., integrated circuit card identifier (ICCID)) or subscriber information (e.g., international mobile subscriber identity (IMSI).

The memory 230 (e.g., memory 130) may include an internal memory 232 and/or an external memory 234. The internal memory 232 may include, for example, at least one of a volatile memory (e.g., a random access memory (RAM), a dynamic RAM (DRAM), a static RAM (SRAM), a synchronous dynamic RAM (SDRAM), and the like), and a non-volatile Memory (e.g., a read only memory (ROM), a one time programmable ROM (OTPROM), a programmable ROM (PROM), an erasable and programmable ROM (EPROM), an electrically erasable and programmable ROM (EEPROM), a mask ROM, a flash ROM, a not and (NAND) flash memory, a not or (NOR) flash memory, etc.), a hard drive, a solid state drive (SSD), etc.

According to an embodiment, the external memory 234 may further include a flash drive, for example, a compact flash (CF), a secure digital (SD), a micro-SD, a mini-SD, an extreme digital (xD), or a memory stick. The external memory 1234 may be functionally connected to the electronic device 201 through various interfaces. According to an embodiment, the electronic device 201 may further include a storage device (or storage medium) such as a hard drive.

The sensor module 240 measures a physical quantity or detects an operation state of the electronic device 201, and converts the measured or detected information to an electronic signal. The sensor module 240 may include, for example, at least one of a gesture sensor 240A, a gyro sensor 240B, an atmospheric pressure (barometer) sensor 240C, a magnetic sensor 240D, an acceleration sensor 240E, a grip sensor 240F, a proximity sensor 240G, a color sensor 240H (e.g., red, green, and blue (RGB) sensor), a biometric sensor 240I, a temperature/humidity sensor 240J, an illuminance (e.g., light) sensor 240K, and a ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, a fingerprint sensor (not illustrated), and the like. The sensor module 240 may further include a control circuit for controlling one or more sensors included in the sensor module 240. In embodiments, the electronic device 201 is capable of including a processor, configured as part of the application processor 210 or a separate component, for controlling the sensor module 240. In this case, while the application processor 210 is operating in sleep mode, the processor is capable of controlling the sensor module 240.

The input device 250 may include various input circuitry, such as, for example, and without limitation, a touch panel 252, a (digital) pen sensor 254, a key 256, and an ultrasonic input device 258. For example, the touch panel 252 may recognize a touch input in at least one type of a capacitive type, a resistive type, an infrared type, and an acoustic wave type. The touch panel 252 may further include a control circuit. In the capacitive type, the touch panel 252 may recognize proximity as well as a direct touch. The touch panel 252 may further include a tactile layer. In this event, the touch panel 252 provides a tactile reaction to the user.

The (digital) pen sensor 254 may be implemented, for example, using a method identical or similar to a method of receiving a touch input of the user, or using a separate recognition sheet. The key 256 may include, for example, a physical button, an optical key, or a key pad. The ultrasonic input device 258 is a device which may detect an acoustic wave by a microphone (e.g., a microphone 288) through an input means generating an ultrasonic signal to identify data and may perform wireless recognition.

The display 260 (e.g., display 160) includes a panel 262, a hologram unit or device 264, and a projector 266. The panel 262 may be implemented to be, for example, flexible, transparent, or wearable. The panel 262 may also be incorporated into one module together with the touch panel 252. The According to one embodiment, the panel 262 may include a pressure sensor (or force sensor) capable of measuring the intensity of the pressure on the user's touch. The pressure sensor may be integrated with the touch panel 252, or may be implemented by one or more sensors separate from the touch panel 252. The hologram device 264 shows a stereoscopic image in the air by using interference of light. The projector 266 projects light on a screen to display an image. For example, the screen may be located inside or outside the electronic device 201.

The interface 270 may include various interface circuitry, such as, for example, and without limitation, a HDMI 272, an USB 274, an optical interface 276, and a D-subminiature (D-sub) 278. The interface 270 may be included in, for example, the communication interface 170 illustrated in FIG. 1. Additionally or alternatively, the interface 270 may include, for example, a mobile high-definition link (MHL) interface, an SD card/multi-media card (MMC), or an infrared data association (IrDA) standard interface.

The audio module 280 bi-directionally converts a sound and an electronic signal. At least some components of the audio module 280 may be included in, for example, the input/output interface 150 illustrated in FIG. 1. The audio module 280 processes sound information input or output through, for example, a speaker 282, a receiver 284, an earphone 286, the microphone 288 and the like.

The camera module 291 is a device which may photograph a still image and a video. According to an embodiment, the camera module 291 may include one or more image sensors (e.g., a front sensor or a back sensor), an image signal processor (ISP) or a flash (e.g., an LED or xenon lamp).

The power managing module 295 manages power of the electronic device 201. Although not illustrated, the power managing module 295 may include, for example, a power management integrated circuit (PMIC), a charger IC, or a battery or fuel gauge.

The PMIC may be mounted to, for example, an integrated circuit or a SoC semiconductor. A charging method may be divided into wired and wireless methods. The charger IC charges a battery and prevent over voltage or over current from flowing from a charger. According to an embodiment, the charger IC includes a charger IC for at least one of the wired charging method and the wireless charging method. The wireless charging method may include, for example, a magnetic resonance method, a magnetic induction method and an electromagnetic wave method, and additional circuits for wireless charging, for example, circuits such as a coil loop, a resonant circuit, a rectifier and the like may be added.

The battery fuel gauge measures, for example, a remaining quantity of the battery 296, or a voltage, a current, or a temperature during charging. The battery 296 may store or generate electricity and supply power to the electronic device 201 by using the stored or generated electricity. The battery 296 may include a rechargeable battery or a solar battery.

The indicator 297 shows particular statuses of the electronic device 201 or a part (e.g., AP 210) of the electronic device 201, for example, a booting status, a message status, a charging status and the like. The motor 298 converts an electrical signal to a mechanical vibration. Although not illustrated, the electronic device 201 may include a processing unit (e.g., GPU) for supporting a module TV. The processing unit for supporting the mobile TV may process, for example, media data according to a standard of digital multimedia broadcasting (DMB), digital video broadcasting (DVB), media flow and the like.

Each of the components of the electronic device according to various embodiments may be implemented by one or more components and the name of the corresponding component may vary depending on a type of the electronic device. The electronic device according to various embodiments may include at least one of the above described components, a few of the components may be omitted, or additional components may be further included. Also, some of the components of the electronic device according to various embodiments may be combined to form a single entity, and thus may equivalently execute functions of the corresponding components before being combined.

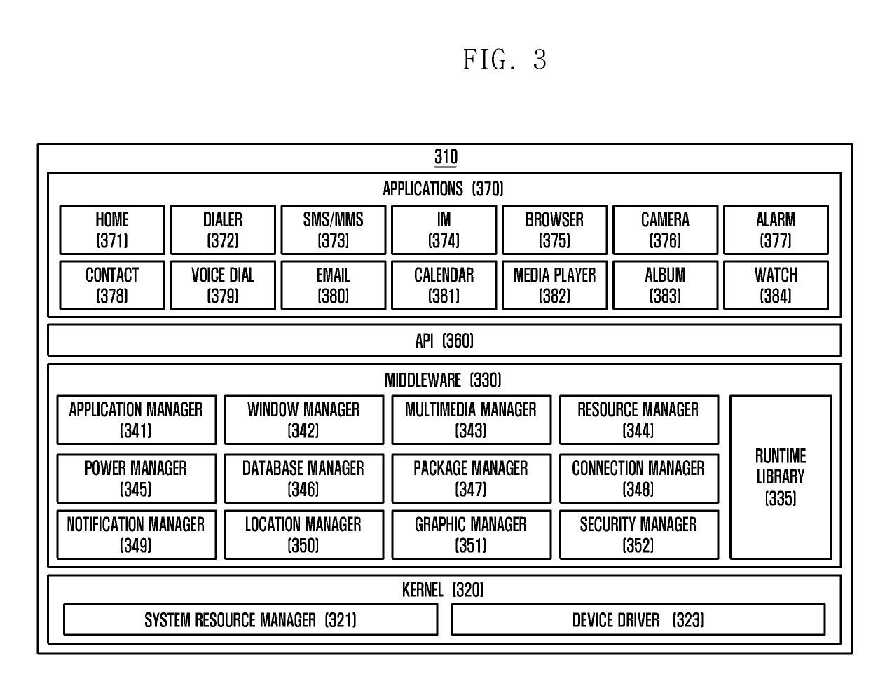

FIG. 3 is a block diagram illustrating an example configuration of a program module according to various example embodiments of the present disclosure.

Referring to FIG. 3, a programming module 310 may be included, e.g. stored, in the electronic apparatus 101, e.g. the memory 130, as illustrated in FIG. 1. At least a part of the programming module 310 (e.g., program 140) may be realized by software, firmware, hardware, and/or combinations of two or more thereof. The programming module 310 may include an OS that is implemented in hardware, e.g., the hardware 200 to control resources related to an electronic device, e.g., the electronic device 101, and/or various applications. e.g., application 147, driven on the OS. For example, the OS may be Android, iOS, Windows, Symbian, Tizen, Bada, and the like.

Referring to FIG. 3, the programming module 310 may include a kernel 320 (e.g., kernel 141), middleware 330 (e.g., middleware 143), an API 360 (e.g., API 145), and the applications 370 (e.g., application 147). At least part of the program module 310 may be preloaded on the electronic device or downloaded from a server (e.g., an external electronic device 102, 104, server 106, etc.).

The kernel 320 may include a system resource manager 321 and/or a device driver 323. The system resource manager 321 may control, allocate, and/or collect system resources. The system resource manager 321 may include, for example, a process manager, a memory manager, and a file system manager. The device driver 323 may include, for example, a display driver, a camera driver, a BT driver, a shared memory driver, a USB driver, a keypad driver, a Wi-Fi driver, and an audio driver. Further, according to an embodiment, the device driver 323 may include an inter-process communication (IPC) driver (not illustrated).

The middleware 330 may include a plurality of modules implemented in advance for providing functions commonly used by the applications 370. Further, the middleware 330 may provide the functions through the API 360 such that the applications 370 may efficiently use restricted system resources within the electronic apparatus. For example, as illustrated in FIG. 3, the middleware 330 may include at least one of a runtime library 335, an application manager 341, a window manager 342, a multimedia manager 343, a resource manager 344, a power manager 345, a database manager 346, a package manager 347, a connectivity (e.g., connection) manager 348, a notification manager 349, a location manager 350, a graphic manager 351, and a security manager 352.

The runtime library 335 may include a library module that a compiler uses in order to add a new function through a programming language while one of the applications 370 is being executed. According to an embodiment, the runtime library 335 may perform an input/output, memory management, and/or a function for an arithmetic function.

The application manager 341 may manage a life cycle of at least one of the applications 370. The window manager 342 may manage graphical user interface (GUI) resources used by a screen. The multimedia manager 343 may detect formats used for reproduction of various media files, and may perform encoding and/or decoding of a media file by using a codec suitable for the corresponding format. The resource manager 344 may manage resources such as a source code, a memory, and a storage space of at least one of the applications 370.

The power manager 345 may manage a battery and/or power, while operating together with a basic input/output system (BIOS), and may provide power information used for operation. The database manager 346 may manage generation, search, and/or change of a database to be used by at least one of the applications 370. The package manager 347 may manage installation and/or an update of an application distributed in a form of a package file.

For example, the connectivity (e.g., connection) manager 348 may manage wireless connectivity such as Wi-Fi or BT. The notification manager 349 may display and/or notify of an event, such as an arrival message, a promise, a proximity notification, and the like, in such a way that does not disturb a user. The location manager 350 may manage location information of an electronic apparatus. The graphic manager 351 may manage a graphic effect which will be provided to a user, and/or a user interface related to the graphic effect. The security manager 352 may provide all security functions used for system security and/or user authentication. According to an embodiment, when an electronic apparatus, e.g., the electronic device (or apparatus) 101, has a telephone call function, the middleware 330 may further include a telephony manager for managing a voice and/or video communication function of the electronic apparatus.

The middleware 330 may generate and use a new middleware module through various functional combinations of the aforementioned internal element modules. The middleware 330 may provide modules specialized according to types of OSs in order to provide differentiated functions. Further, the middleware 330 may dynamically remove some of the existing elements and/or add new elements. Accordingly, the middleware 330 may exclude some of the elements described in the various embodiments, further include other elements, and/or substitute the elements with elements having a different name and performing a similar function.

The API 360 is a set of API programming functions, and may be provided with a different configuration according to the OS. For example, in a case of Android or iOS, one API set may be provided for each of platforms, and in a case of Tizen, two or more API sets may be provided.

The applications 370 may include one or more applications for performing various functions, e.g., home 371, dialer 372, SMS/MMS 373, instant message (IM) 374, browser 375, camera 376, alarm 377, contact 378, voice dial 379, email 380, calendar 381, media player 382, album 383, clock (e.g., watch) 384, or the like. Additionally, or alternatively, although not shown, the applications 370 may include various other applications, such as, for example, and without limitation, health care (e.g., an application for measuring amount of exercise, blood sugar level, etc.), and environment information (e.g., an application for providing atmospheric pressure, humidity, temperature, etc.)

According to an embodiment, the applications 370 are capable of including an application for supporting information exchange between an electronic device and an external device, which is hereafter called ‘information exchange application’. The information exchange application is capable of including a notification relay application for relaying specific information to external devices or a device management application for managing external devices.

For example, the notification relay application is capable of including a function for relaying notification information, created in other applications of the electronic device to external devices. In addition, the notification relay application is capable of receiving notification information from external devices to provide the received information to the user.

The device management application is capable of managing (e.g., installing, removing or updating) at least one function of an external device communicating with the electronic device. Examples of the function are a function of turning-on/off the external device or part of the external device, a function of controlling the brightness (or resolution) of the display, applications running on the external device, services provided by the external device, etc. Examples of the services are a call service, messaging service, etc.

According to an embodiment, the applications 370 are capable of including an application (e.g., a health care application of a mobile medical device, etc.) specified attributes of an external device. According to an embodiment, the applications 370 are capable of including applications received from an external device. According to an embodiment, the applications 370 are capable of including a preloaded application or third party applications that can be downloaded from a server. It should be understood that the components of the program module 310 may be called different names according to types of operating systems.

According to various embodiments, at least part of the program module 310 can be implemented with software, firmware, hardware, or any combination thereof. At least part of the program module 310 can be implemented (e.g., executed) by an application processor (e.g., processor 210). At least part of the programing module 310 may include modules, programs, routines, sets of instructions or processes, etc., in order to perform one or more functions.

The term “module” used in the disclosure may refer to, for example, a unit including at least one combination of hardware (e.g., circuitry), software, and firmware. The “module” may be interchangeably used with a term, such as unit, logic, logical block, component, and/or circuit. The “module” may be a minimum unit of an integrally configured article and/or a part thereof. The “module” may be a minimum unit performing at least one function and/or a part thereof. The “module” may be mechanically and/or electronically implemented. For example, and without limitation, the “module” according to the disclosure may include at least one of processing circuitry (e.g., a CPU), a dedicated processor, an application-specific IC (ASIC) chip, a field-programmable gate arrays (FPGA), and a programmable-logic device for performing operations which has been known and/or are to be developed.

According to various embodiments, at least some of the devices (e.g., modules or functions thereof) or the method (e.g., operations) according to the disclosure may be implemented by a command stored in a computer-readable storage medium in a programming module form. When the instructions are executed by at least one processor (e.g., the processor 120), the at least one processor may perform functions corresponding to the instructions. The computer-readable storage medium may be, for example, the memory 130. At least a part of the programming module may be implemented (e.g., executed) by, for example, the processor 120. At least some of the programming modules may include, for example, a module, a program, a routine, a set of instructions or a process for performing one or more functions.

The computer-readable recording medium may include magnetic media such as a hard disk, a floppy disk, and a magnetic tape, optical media such as a compact disc ROM (CD-ROM) and a DVD, magneto-optical media such as a floptical disk, and hardware devices specially configured to store and perform a program instruction (e.g., programming module), such as a ROM, a RAM, a flash memory and the like. In addition, the program instructions may include high level language codes, which may be executed in a computer by using an interpreter, as well as machine codes made by a compiler. The aforementioned hardware device may be configured to operate as one or more software modules in order to perform the operation of the disclosure, and vice versa.

The module or programming module of the disclosure may include at least one of the aforementioned components with omission of some components or addition of other components. The operations of the modules, programming modules, or other components may be executed in series, in parallel, recursively, or heuristically. Also, some operations may be executed in different order, omitted, or extended with other operations.

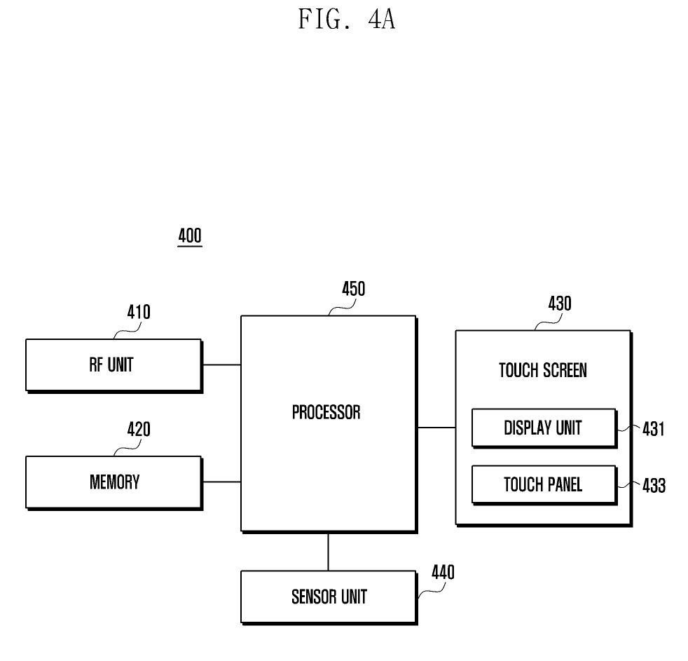

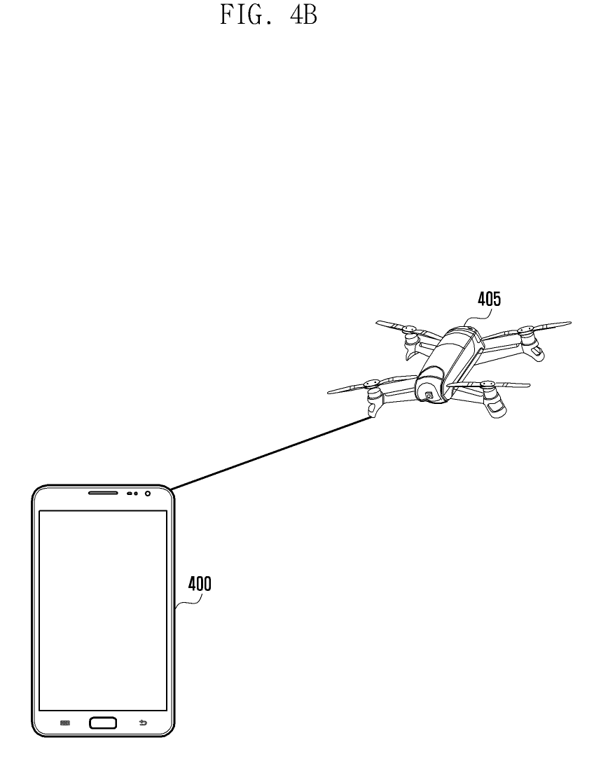

FIG. 4A is a block diagram illustrating an example configuration of an electronic device according to various example embodiments of the present disclosure.

With reference to FIG. 4A, an electronic device 400 may include a radio frequency (RF) unit (e.g., including RF circuitry) 410, memory 420, touch screen 430, sensor unit (e.g., including one or more sensors) 440, and processor (e.g., including processing circuitry) 450.

The RF unit 410 (e.g., the communication interface 170 of FIG. 1, the communication module 220 of FIG. 2) according to various example embodiments of the present disclosure may include various RF circuitry and connect communication between the electronic device 400 and the moving device. The RF unit 410 may have a function of transmitting and receiving a signal of the electronic device 400 and the moving device. The RF unit 410 may transmit a signal on a function of a moving device determined under the control of the processor 450 to the moving device.

The memory 420 (e.g., the memory 130 of FIG. 1, the memory 230 of FIG. 2) according to various example embodiments of the present disclosure may store a predetermined magnitude of pressure value for determining whether a touch input detected in a user interface is a first touch input or a second touch input. The memory 420 may store a user interface to be displayed based on detection of the first touch input or the second touch input. The memory 420 may store functions for controlling a moving device mapped to a first touch input (or a second touch input) and a moving direction of the first touch input (or a second touch input) detected in the user interface.

The touch screen 430 according to various example embodiments of the present disclosure may be configured in an integral form including a display unit 431 (e.g., the display 160 of FIG. 1, the display 260 of FIG. 2) and a touch panel 433 (e.g., the input device 250 of FIG. 2).

In various example embodiments of the present disclosure, the display unit 431 may display a user interface for controlling a moving device connected through the RF unit 410 under the control of the processor 450. The user interface may include at least two objects. The touch panel 433 may receive a touch input from the at least one object.

In various example embodiments of the present disclosure, the touch panel 433 may include a pressure sensor and measure (determine) pressure intensity of the touch input received using the pressure sensor.

The display unit 431 according to various example embodiments of the present disclosure may receive and display an image photographed through at least one camera provided at the moving device under the control of the processor 450. The touch panel 433 may receive a gesture for controlling a camera function of the moving device in the image. The display unit 431 may receive and display an image changed according to the camera function control in response to the gesture under the control of the processor 450 from the moving device.

The sensor unit 440 (e.g., the sensor module 240 of FIG. 2) according to various example embodiments of the present disclosure may include various sensors, such as, for example, and without limitation, at least one of a gesture sensor, gyro sensor, and acceleration sensor.

In various example embodiments of the present disclosure, the sensor unit 440 may detect a movement of the electronic device 400 using the acceleration sensor and the gyro sensor. The sensor unit 440 may transmit sensor information according to a movement of the electronic device 400 to the processor 450.

The processor 450 according to various example embodiments of the present disclosure may include various processing circuitry and control the electronic device to display a user interface including at least two objects for controlling the moving device connected through the RF unit 410. The processor 450 may control a function of the moving device based on a touch input detected in the at least one object and a moving direction of the touch input.

In various example embodiments of the present disclosure, a function of the moving device may include at least one of a function of adjusting a speed of the moving device, a function of setting a flying mode (e.g., general normal mode, hovering mode, headless mode), a camera function (picture photographing, video record function), and take-off, landing, direction change, left direction movement, right direction movement, forward movement, and backward movement functions of the moving device.

In various example embodiments of the present disclosure, when a touch input is detected in or by the user interface, the processor 450 may determine whether pressure intensity of the touch input exceeds a predetermined magnitude. If pressure intensity of the touch input exceeds a predetermined magnitude, the processor 450 may determine the touch input to be a first touch input and determine a function of the moving device based on the first touch input and a moving direction of the first touch input.

In various example embodiments of the present disclosure, the first touch input may be one of a single pressure touch input and a multi pressure touch input.

In various example embodiments of the present disclosure, when the first touch input is detected, the processor 450 may output at least one of visual sense feedback, auditory sense feedback, and tactile sense feedback.

In various example embodiments of the present disclosure, the processor 450 may control the electronic device to detect a movement of the electronic device 400 using an acceleration sensor and a gyro sensor while a first touch input is detected. The processor 450 may determine a function of the moving device based on a movement of the electronic device 400.

In various example embodiments of the present disclosure, a function of the moving device determined based on the first touch input and a movement of the electronic device 400 may include at least one of a function of setting a flying mode (e.g., automatic flying mode, self-portrait (selfie) cam mode, follow me function, or the like) of the moving device, a function of urgently stopping an operation of the moving device, and a function of stopping a movement of the moving device.

In various example embodiments of the present disclosure, if pressure intensity of the touch input does not exceed a predetermined magnitude, the processor 450 may determine the touch input to a second touch input and determine a function of the moving device based on the second touch input.

In various example embodiments of the present disclosure, the second touch input may be, for example, one of a single touch input and a multi touch input.

In various example embodiments of the present disclosure, the processor 450 may transmit a control signal of a function of the moving device determined based on at least one of the first touch input and the second touch input to the moving device through the RF unit 410.

In various example embodiments of the present disclosure, the processor 450 may control the electronic device to receive and display an image photographed by at least one camera provided at the moving device from the moving device connected through the RF unit 410. When a gesture for controlling a camera function of the moving device is detected in the image, the processor 450 may transmit a control signal for controlling at least one of a function of adjusting a movement of the moving device and a function of adjusting a direction of the camera to the moving device through the RF unit 410.

FIG. 4B is a diagram illustrating an example electronic device and a moving device connected through an RF unit according to various example embodiments of the present disclosure.

With reference to FIG. 4B, in various example embodiments of the present disclosure, the electronic device 400 may be connected to a moving device 405 through the RF unit 410.

In various example embodiments of the present disclosure, when an input for controlling the moving device 405 is detected, the electronic device 400 may determine a function of the moving device 405 based on the input. The electronic device 400 may transmit a control signal of the function to the moving device 405 through the RF unit 410. The moving device 405 may control a function of the moving device 405 based on the received control signal.

Hereinafter, in various example embodiments of the present disclosure, the moving device 405 is assumed to be a drone, but the present disclosure is not limited thereto.

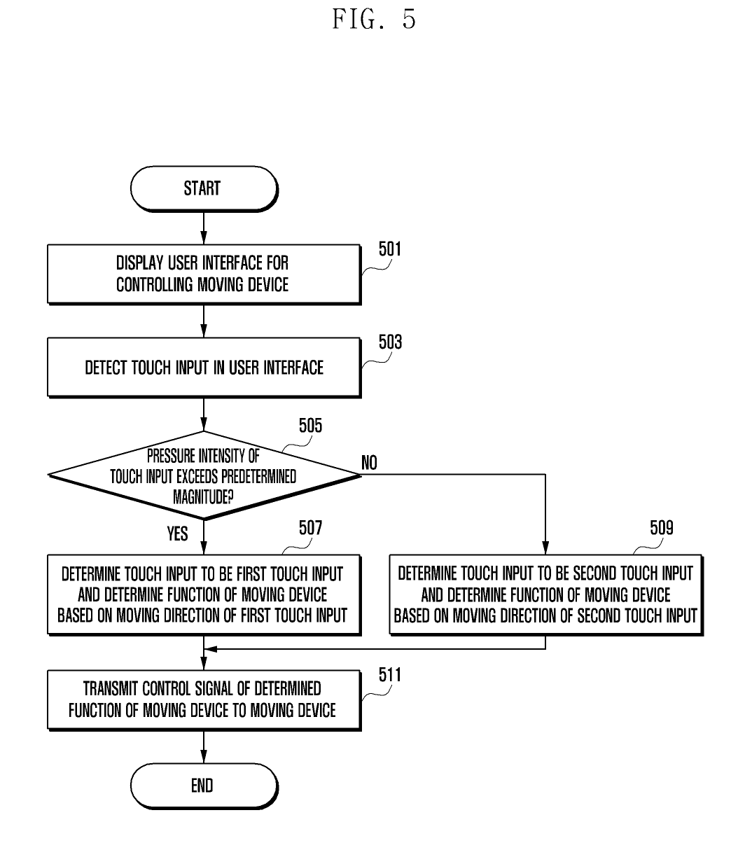

FIG. 5 is a flowchart illustrating an example method for controlling a moving device according to various example embodiments of the present disclosure.

With reference to FIG. 5, the processor 450 may control the electronic device to display a user interface for controlling a moving device connected through the RF unit 410 at operation 501.

In various example embodiments of the present disclosure, the user interface may include at least two objects. The processor 450 may control a function of the moving device based on a touch input detected in or at the at least one object and a moving direction of the touch input. This will be described in greater detail below with reference to operations 503 to 511.

The processor 450 may control the electronic device to detect a touch input in the user interface at operation 503.

In various example embodiments of the present disclosure, the processor 450 may control the electronic device to detect at least one of a single touch input, multi touch input, single pressure touch input, and multi pressure touch input in the user interface. As described above, the user interface may include at least two objects, and the processor 450 may control the electronic device to detect a touch input in at least one object. For example, the processor 450 may control the electronic device to detect at least one of a single touch input and a single pressure touch input at one object and to detect at least one of a multi touch input and a multi pressure touch input at two objects.

The processor 450 may determine whether pressure intensity of the touch input exceeds a predetermined magnitude at operation 505. In other words, the processor 450 may determine whether a pressure touch input has been detected in a user interface.

If pressure intensity of the touch input exceeds a predetermined magnitude, the processor 450 may determine the touch input to be a first touch input and determine a function of the moving device based on the first touch input and a moving direction of the first touch input at operation 507.

In various example embodiments of the present disclosure, the first touch input may include at least one of a single pressure touch input and a multi pressure touch input. The processor 450 may determine a function of a moving device based on the first touch input and a moving direction of the first touch input.

In various example embodiments of the present disclosure, when the single pressure touch input is detected, as a condition of determining a function of the moving device, a position (e.g., an object in which the single pressure touch input is detected among at least two objects) in which the single pressure touch input is detected may be further considered.

In various example embodiments of the present disclosure, a function of a moving device determined based on the first touch input and a moving direction of the first touch input may include at least one of a function, for example, a function of adjusting a speed of the moving device, a function of setting a flying mode (e.g., general mode, hovering mode, headless mode), and a camera function (picture photographing, video record function) other than a function of controlling a movement of the moving device, or the like.

If pressure intensity of the touch input does not exceed a predetermined magnitude, the processor 450 may determine the touch input to be a second touch input and determine a function of the moving device based on the second touch input at operation 509.

In various example embodiments of the present disclosure, the second touch input may include at least one of, for example, a single touch input and a multi touch input. The processor 450 may determine a function of the moving device based on the second touch input and a moving direction of the second touch input.

In various example embodiments of the present disclosure, when the single touch input is detected, as a condition of determining a function of the moving device, a position (e.g., an object in which the single touch input is detected among at least two objects) in which the single touch input is detected may be further considered.

In various example embodiments of the present disclosure, a function of a moving device determined based on the second touch input and a moving direction of the second touch input may be a function for controlling a movement of the moving device and may include at least one of, for example, take-off, landing, direction change, left direction movement, right direction movement, forward movement, and backward movement functions of the moving device, or the like.

The processor 450 may transmit a control signal of the determined function of the moving device to the moving device through the RF unit 410 at operation 511.

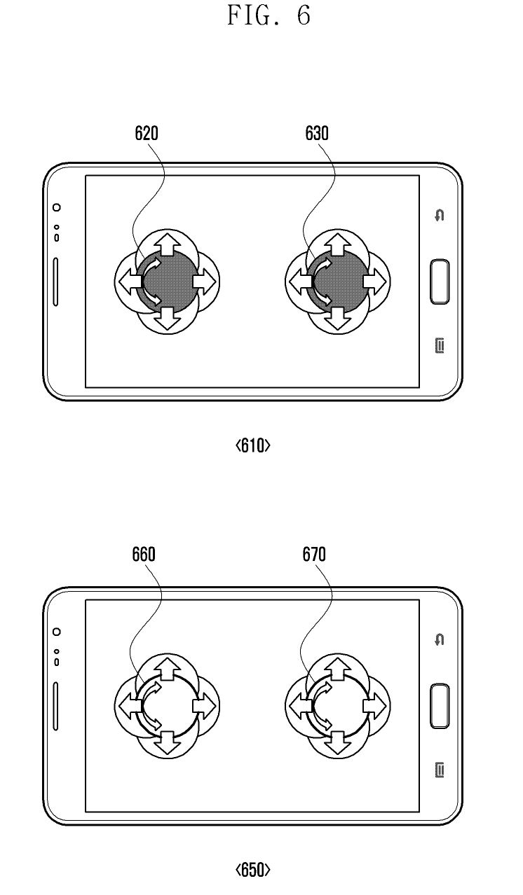

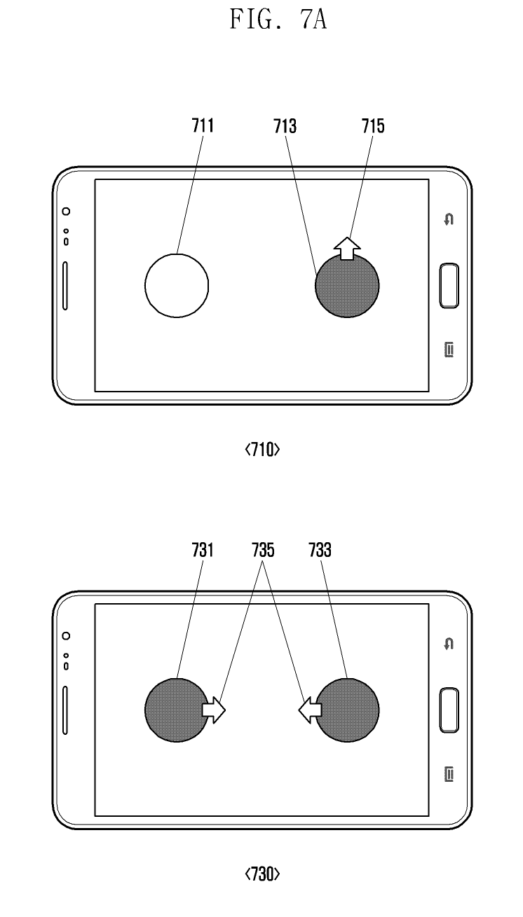

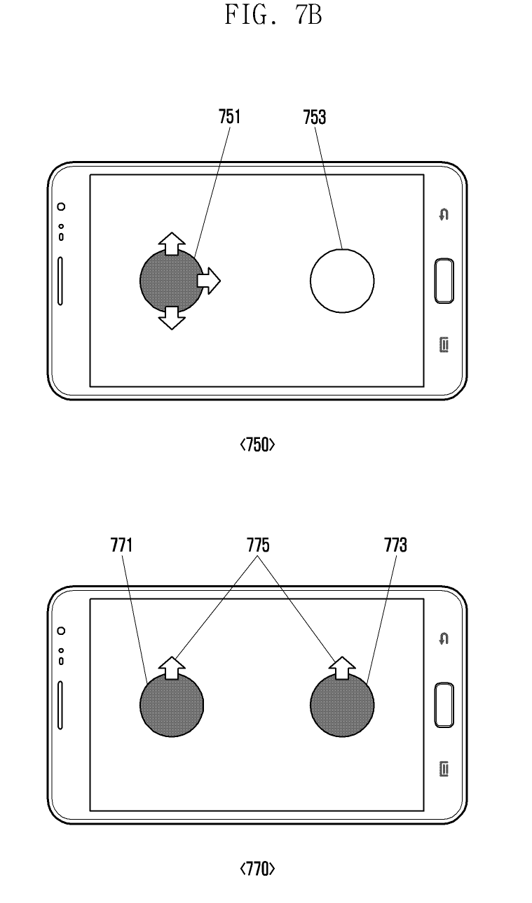

A more detailed description of a method for controlling a moving device based on the touch input and a moving direction of the touch input will be described below with reference to FIGS. 6 to 7B.

FIG. 6 is a diagram illustrating an example method for controlling a moving device according to various example embodiments of the present disclosure.

With reference to FIG. 6, in various example embodiments of the present disclosure, as shown in <610> and <650>, the processor 450 may control the electronic device to display a user interface for controlling the moving device connected through the RF unit 410. The user interface may include at least two objects.

In various example embodiments of the present disclosure, the user interface displays only at least two objects, but the present disclosure is not limited thereto and the user interface may, for example, receive and display an image photographed by at least one camera provided at the moving device from the moving device.

In various example embodiments of the present disclosure, when a first touch input (e.g., a touch input having pressure intensity exceeding a predetermined magnitude) is detected in the user interface, the processor 450 may, for example, control the electronic device to visually display differently an object in which the first touch input is detected from an object in which the first touch input is not detected.

For example, when a first touch input is detected in a first object 620 and a second object 630, the processor 450 may, for example, control the electronic device to apply and display a shaded effect to the first object 620 and the second object 630, as illustrated in <610>.

In various example embodiments of the present disclosure, when a first touch input is not detected in a first object 660 and a second object 670 (e.g., a second touch input (e.g., a touch input having pressure intensity that does not exceed a predetermined magnitude) is detected), the processor 450 may, for example, control the electronic device to display the first object 660 and the second object 670 in which a shaded effect is not applied, as illustrated in <650>.

In various example embodiments of the present disclosure, the processor 450 may determine a function of the moving device based on a first touch input and a moving direction of the first touch input (or a second touch input and a moving direction of the second touch input) detected in the first objects 620 and 660 and/or the second objects 630 and 670.

In various example embodiments of the present disclosure, by visually displaying an object in which the first touch input is detected differently from an object in which the first touch input is not detected, a user may intuitionally determine whether a touch input or a pressure touch input has been detected in at least one object. In other words, the user may intuitionally know entrance to a mode for controlling a function of the moving device according to the first touch input.

In various example embodiments of the present disclosure, it is assumed that an object in which the first touch input is detected is visually displayed differently from an object in which the first touch input is not detected, but the present disclosure is not limited thereto. For example, when the first touch input is detected, the processor 450 may, for example, output at least one of auditory sense feedback and tactile sense feedback, or the like.

FIGS. 7A and 7B are diagrams illustrating an example method for controlling a moving device according to various example embodiments of the present disclosure.

With reference to FIG. 7A, in various example embodiments of the present disclosure, as illustrated in <710>, while a user interface including a first object 711 and a second object 713 for controlling the moving device is displayed, the processor 450 may control the electronic device to detect a first touch input (e.g., single pressure touch input) at the second object 713. When the first touch input is detected, the processor 450 may output at least one of visual sense feedback, auditory sense feedback, and tactile sense feedback.

In various example embodiments of the present disclosure, the processor 450 may determine a function of a moving device based on a first touch input detected at the second object 713 and a moving direction of the first touch input and transmit a control signal thereof to the moving device.

For example, in a state in which a single pressure touch input is maintained at the second object 713, when upward drag is detected, the processor 450 may, for example, determine the upward drag to a camera photographing function of the moving device and transmit a control signal thereof to the moving device.

In various example embodiments of the present disclosure, although not shown, while performing the camera photographing function, when a multi pressure touch input is detected at the first object 711 and the second object 713, the processor 450 may, for example, determine the multi pressure touch input to a function of capturing the photographed image and transmit a control signal thereof to the moving device.

In various example embodiments of the present disclosure, as illustrated in <730>, while a user interface including a first object 731 and a second object 733 for controlling the moving device is displayed, the processor 450 may control the electronic device to detect a first touch input (e.g., multi pressure touch input) at the first object 731 and the second object 733. While a multi pressure touch input is maintained at the first object 731 and the second object 733, when drag 735 to a right direction at the first object 731 and to the left direction at the second object 733 is detected, the processor 450 may, for example, determine the drag to a camera record function of the moving device and transmit a control signal thereof to the moving device.

With reference to FIG. 7B, in various example embodiments of the present disclosure, as illustrated in <750>, while a user interface including a first object 751 and a second object 753 for controlling the moving device is displayed, the processor 450 may control the electronic device to detect a first touch input (e.g., single pressure touch input) at the first object 751. In a state in which a single pressure touch input is maintained at the first object 751, when upward drag is detected, in order to operate the moving device in a general mode, the processor 450 may transmit a control signal to the moving device. In a state in which a single pressure touch input is maintained at the first object 751, when drag to the right direction is detected, in order to operate the moving device in a hovering mode, the processor 450 may transmit a control signal to the moving device. In a state in which a single pressure touch input is maintained at the first object 751, when downward drag is detected, in order to operate the moving device in a headless mode, the processor 450 may, for example, transmit a control signal to the moving device.

In various example embodiments of the present disclosure, as illustrated in <770>, while a user interface including a first object 771 and a second object 773 for controlling the moving device is displayed, the processor 450 may control the electronic device to detect a first touch input (e.g., multi pressure touch input) at the first object 771 and the second object 773. While a multi pressure touch input is maintained at the first object 771 and the second object 773, when upward drag 775 is detected at the first object 771 and the second object 773, the processor 450 may, for example, transmit a control signal for increasing a speed of the moving device to the moving device.

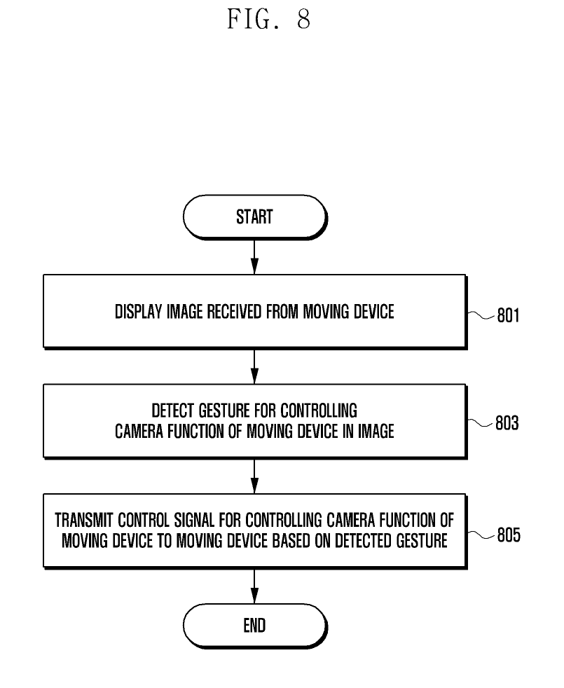

FIG. 8 is a flowchart illustrating an example method for controlling a camera function of a moving device according to various example embodiments of the present disclosure.

With reference to FIG. 8, the processor 450 may control the electronic device to display an image received from a moving device connected through the RF unit 410 at operation 801.

The processor 450 may control the electronic device to receive and display an image photographed by at least one camera provided in the moving device from the moving device through the RF unit 410.

The processor 450 may control the electronic device to detect a gesture for controlling a camera function of the moving device in the image at operation 803.

In various example embodiments of the present disclosure, a function of controlling the camera may, for example, include at least one of a function of adjusting a movement of the moving device and a function of adjusting a direction of the camera.

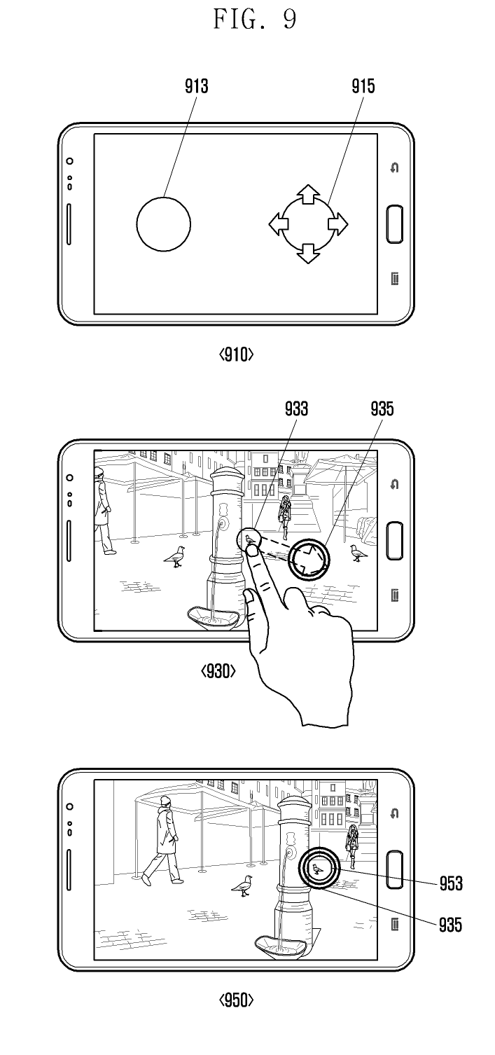

A more detailed description of a method of controlling a camera function of a moving device based on a detected gesture in an image received from the moving device will be described below with reference to FIG. 9.

The processor 450 may transmit a control signal for controlling a camera function of the moving device to the moving device through the RF unit 410 based on the detected gesture at operation 805.

FIG. 9 is a diagram illustrating an example method for controlling a camera function of a moving device according to various example embodiments of the present disclosure.

With reference to FIG. 9, in various example embodiments of the present disclosure, as illustrated in FIG. 7A, in a state in which a single pressure touch input is maintained at the second object 713, when upward drag is detected, the processor 450 may, for example, determine the upward drag to a camera photographing function of the moving device and transmit a control signal thereof to the moving device.

When the moving device receives a control signal of a camera photographing function from the electronic device, the moving device may execute the camera photographing function and transmit an image photographed by at least one camera to the electronic device through the RF unit 410.

The processor 450 may control the electronic device to display an image received from the moving device.

In various example embodiments of the present disclosure, the processor 450 may control the electronic device to detect a gesture for controlling a camera function of the moving device in an image received according to execution of the camera function.

In various example embodiments of the present disclosure, a function of controlling the camera may include at least one of a function of adjusting a movement of the moving device and a function of adjusting a direction of the camera.

For example, the processor 450 may control the electronic device to display a user interface as illustrated in <910> including a first object 913 and a second object 915 for controlling a function of the moving device, for example, to a camera function. The processor 450 may control the electronic device to detect a first touch input (e.g., a single pressure touch input) at the second object 915 of the user interface as illustrated in <910>. The processor 450 may transmit a signal that controls a moving direction of the moving device to the moving device based on drag to a detected specific direction, for example, at least one direction of four directions of the right side, the left side, the upper side, and the lower side while a single pressure touch input is maintained at the second object 915.

When the moving device receives a signal that controls a moving direction from the electronic device, the moving device may transmit an image photographed based on the received signal that controls the moving direction to the electronic device through the RF unit 410.

The processor 450 may control the electronic device to receive and display an image photographed based on the moving direction from the moving device.

In various example embodiments of the present disclosure, the processor 450 may control the electronic device to detect a gesture for adjusting a camera direction of the moving device in an image received from the moving device. For example, the processor 450 may control the electronic device to detect a first touch input (e.g., a touch input having pressure intensity exceeding a predetermined magnitude) at an object 933 to focus in the image, as illustrated in <930>. The processor 450 may control the electronic device to detect a drag input moving to a predetermined area 935 (e.g., an area in which the second object is positioned) of the touch screen 430 while the first touch input is maintained at the object 933. The processor 450 may transmit a control signal of a camera direction (e.g., vertical movement or lateral rotation) determined based on a drag input and the object 933 in which the first touch input is detected to the moving device.

When the moving device receives a control signal of a camera direction from the electronic device, the moving device may transmit an image photographed based on the control signal to the electronic device through the RF unit 410.

The processor 450 may control the electronic device to receive and display an image of the object 933 photographed based on the determined camera direction from the moving device. For example, as illustrated in <950>, when a camera direction of the moving device is adjusted, the processor 450 may control the electronic device to receive and display an image in which a position of the object 953 is changed.

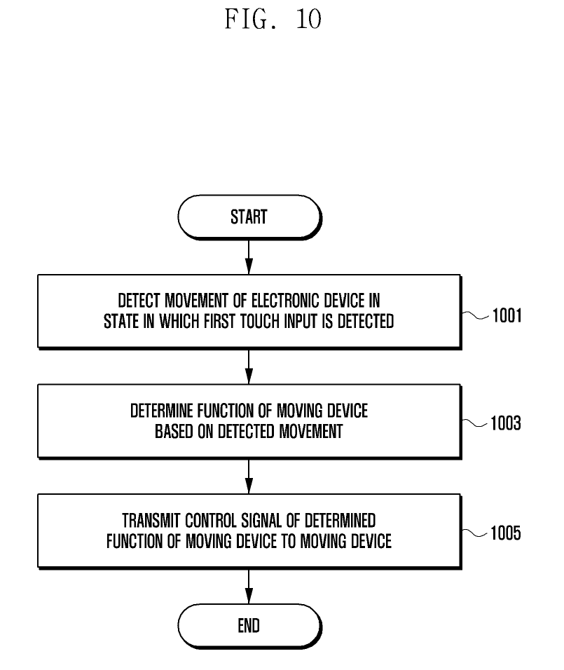

FIG. 10 is a flowchart illustrating an example method for controlling a moving device according to various example embodiments of the present disclosure.

With reference to FIG. 10, in a state in which a first touch input is detected, the processor 450 may control the electronic device to detect a movement of the electronic device at operation 1001.

In various example embodiments of the present disclosure, the processor 450 may control the electronic device to detect a movement in at least one direction of four directions of the right side, the left side, the upper side, and the lower side of the electronic device using an acceleration sensor and a gyro sensor.

The processor 450 may determine a function of a moving device based on the detected movement of the electronic device at operation 1003.

The processor 450 may transmit a control signal of the determined function of the moving device to the moving device through the RF unit 410 at operation 1005.

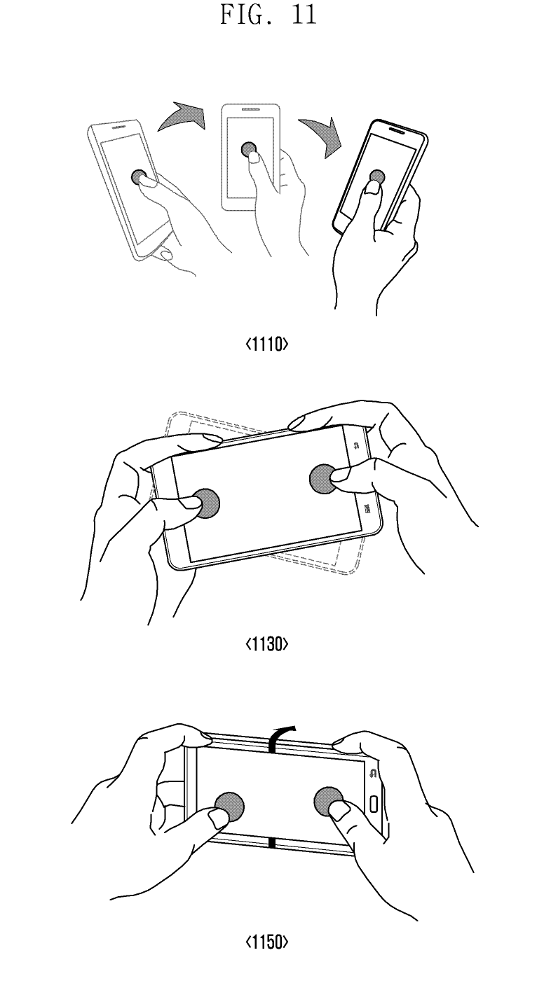

A detailed description of a method of controlling a moving device based on a movement of the electronic device will be described with reference to FIG. 11.

FIG. 11 is a diagram illustrating an example method for controlling a moving device according to various example embodiments of the present disclosure.

With reference to FIG. 11, while a first touch input, for example, a single pressure touch input is detected, when a movement to a lateral direction of the electronic device is repeatedly detected as illustrated in <1110> through the sensor unit 440, the processor 450 may determine the movement to a function of turning on/off power of the moving device and transmit a control signal thereof to the moving device through the RF unit 410.

In various example embodiments of the present disclosure, while a first touch input, for example, a multi pressure touch input is detected, when a movement to a lateral direction of the electronic device is repeatedly detected as illustrated in <1130> through the sensor unit 440, the processor 450 may determine the movement to a function of setting a flying mode of the moving device. For example, a flying mode of the moving device may include an automatic flying mode, selfie cam mode, and follow me mode. The processor 450 may transmit a control signal of a function of setting a flying mode of the moving device to the moving device through the RF unit 410.

In various example embodiments of the present disclosure, while a first touch input, for example, a multi pressure touch input is detected, when a gesture of putting at the bottom according to an upward movement of the electronic device is detected as illustrated in <1150> through the sensor unit 440, the processor 450 may determine the gesture to a function of urgently stopping an operation of the moving device and transmit a control signal thereof to the moving device through the RF unit 410.

In various example embodiments of the present disclosure, a touch input is not detected but when a gesture of putting at the bottom according to an upward movement of the electronic device is detected (not shown) through the sensor unit 440, the processor 450 may determine the gesture to a function of stopping a movement of the moving device and transmit a control signal thereof to the moving device through the RF unit 410. Accordingly, according to various example embodiments of the present disclosure, damage of a moving device can be prevented and/or avoided and a risk that may apply damage to a peripheral object can be removed and/or reduced.

According to various example embodiments of the present disclosure, an electronic device can secure an area for displaying an image received from a moving device without requiring many manipulation buttons.

Further, because the electronic device can control a function of a moving device based on a movement thereof and/or pressure intensity of a touch input, a user can intuitionally and easily control the moving device.

Further, because the electronic device can control a function of a moving device based on a movement thereof and/or pressure intensity of a touch input, a function of the moving device can be simply performed without performing an existing plurality of steps.

Further, because the electronic device provides feedback based on pressure intensity of a touch input for controlling a moving device, an erroneous input of a touch can be prevented and/or reduced.

Although various example embodiments of the present disclosure have been described in detail hereinabove it should be clearly understood that many variations and modifications of the disclosure herein described may be apparent to those skilled in the art and will still fall within the spirit and scope of the example embodiments of the present disclosure as defined in the appended claims and their equivalents.

What is claimed is:

1. An electronic device, comprising:
a radio frequency (RF) unit comprising RF circuitry configured to communicate with a moving device;
a memory;
a touch screen configured to display a user interface for controlling the moving device; and
a processor electrically connected to the RF unit, the memory, and the touch screen,
wherein the memory stores instructions that, when executed by the processor, configure the processor to determine a function of the moving device based on a pressure intensity of a touch input and a moving direction of the touch input when the touch input is detected in the user interface, and to transmit a control signal of the determined function of the moving device to the moving device through the RF unit.

2. The electronic device of claim 1, wherein the instructions when executed by the processor further configure the processor to determine whether the pressure intensity of the touch input exceeds a predetermined magnitude when the touch input is detected, to determine the touch input to be a first touch input, if the pressure intensity of the touch input exceeds a predetermined magnitude, to determine the touch input to be a second touch input, if the pressure intensity of the touch input does not exceed a predetermined magnitude, and to determine a function of the moving device based on a moving direction of the determined first touch input and/or second touch input.

3. The electronic device of claim 2, wherein the instructions when executed by the processor further configure the processor to determine that the first touch input comprising one of: a single pressure touch input and a multi pressure touch input is detected, if the pressure intensity of the touch input exceeds a predetermined magnitude, and to determine that the second touch input comprising one of: a single pressure touch input and a multi pressure touch input is detected, if the pressure intensity of the touch input does not exceed a predetermined magnitude.

4. The electronic device of claim 1, wherein the instructions when executed by the processor further configure the processor to control the touch screen to display a user interface comprising two objects for controlling the moving device.

5. The electronic device of claim 3, wherein the instructions when executed by the processor further configure the processor to determine at least one of: a function of adjusting a speed of the moving device, a function of setting a flying mode, and a camera function, based on the first touch input and a moving direction of the first touch input, and to transmit a control signal of the determined function to the moving device through the RF unit.

6. The electronic device of claim 3, wherein the instructions when executed by the processor configure the processor to determine at least one of: take-off, landing, direction change, left direction movement, right direction movement, forward movement, and backward movement functions of the moving device, based on the second touch input and a moving direction of the second touch input, and to transmit a control signal of the determined function to the moving device through the RF unit.

7. The electronic device of claim 2, wherein the instructions when executed by the processor further configure the processor to output at least one of: visual sense feedback, auditory sense feedback, and tactile sense feedback, if pressure intensity of the touch input exceeds a predetermined magnitude.

8. The electronic device of claim 5, wherein the instructions when executed by the processor further configure the processor to control the touch screen to display a received image, when receiving an image photographed by at least one camera provided in the moving device from the moving device based on execution of the camera function, and to transmit a signal for controlling a camera function of the moving device to the moving device through the RF unit when a gesture for controlling a camera function of the moving device is detected in the displayed image.

9. The electronic device of claim 8, wherein the instructions when executed by the processor further configure the processor to transmit a control signal of at least one of: a function of adjusting a direction of the moving device and a function of adjusting a direction of a camera to the moving device through the RF unit, when a gesture for controlling a camera function of the moving device is detected in the displayed image.

10. The electronic device of claim 2, further comprising a sensor unit comprising at least one sensor that is configured to detect a movement of the electronic device,
wherein the instructions when executed by the processor further configure the processor to determine a function of the moving device based on a movement of the electronic device detected through the sensor unit while the first touch input is detected, and to transmit a control signal of the determined function of the moving device to the moving device through the RF unit.

11. A method for controlling a moving device using an electronic device, the method comprising:
displaying, on a display of the electronic device, a user interface for controlling the moving device connected through an RF unit;
determining, when a touch input is detected in the user interface, a function of the moving device based on a pressure intensity of the touch input and a moving direction of the touch input; and
transmitting a control signal of the determined function of the moving device to the moving device through the RF unit.

12. The method of claim 11, further comprising:
determining, when the touch input is detected, whether the pressure intensity of the touch input exceeds a predetermined magnitude;
determining, if the pressure intensity of the touch input exceeds a predetermined magnitude, the touch input to be a first touch input; and
determining, if the pressure intensity of the touch input does not exceed a predetermined magnitude, the touch input to be a second touch input,
wherein determining, when a touch input is detected in the user interface, a function of the moving device based on the pressure intensity of the touch input and a moving direction of the touch input comprises determining a function of the moving device based on the determined moving direction of the first touch input and/or the second touch input.

13. The method of claim 12, wherein the first touch input is one of: a single pressure touch input and a multi pressure touch input, and the second touch input is one of: a single pressure touch input and a multi pressure touch input.

14. The method of claim 11, wherein the user interface comprises two objects for controlling the moving device.

15. The method of claim 13, wherein a function of the moving device determined based on the first touch input and a moving direction of the first touch input comprises at least one of: a function of adjusting a speed of the moving device, a function of setting a flying mode, and a camera function.

16. The method of claim 13, wherein a function of a moving device determined based on the second touch input and a moving direction of the second touch input comprises at least one of: take-off, landing, direction change, left direction movement, right direction movement, forward movement, and backward movement functions of the moving device.

17. The method of claim 12, further comprising outputting, if the pressure intensity of the touch input exceeds a predetermined magnitude, at least one of: visual sense feedback, auditory sense feedback, and tactile sense feedback.

18. The method of claim 15, further comprising:
receiving, from the moving device, an image photographed by at least one camera provided in the moving device based on execution of the camera function;
displaying the received image; and
transmitting, when a gesture for controlling a camera function of the moving device is detected in the displayed image, a signal for controlling a camera function of the moving device to the moving device through the RF unit.

19. The method of claim 18, wherein the signal for controlling a camera function comprises at least one of: a signal of a function of adjusting a direction of the moving device and a signal of a function of adjusting a direction of the camera.

20. The method of claim 12, further comprising:
determining, when a movement of the electronic device is detected while the first touch input is detected, a function of the moving device based on the movement of the electronic device; and
transmitting a control signal of the determined function of the moving device to the moving device through the RF unit.
